(19) United States
(12) Patent Application Publication
(10) Pub. No.: US 2009/0303136 A1
(43) Pub. Date: Dec. 10, 2009

(54) ANTENNA DEVICE AND COMMUNICATION DEVICE USING THE SAME

(76) Inventors: Akio Kuramoto, Tokyo (JP); Takuji Mochizuki, Kanagawa (JP)

Correspondence Address: Mr. Jackson Chen, 6535 N. STATE HWY 161, IRVING, TX, 75039, US

(21) Appl. No.: 12/278,823

(22) PCT Filed: Jan. 31, 2007
(86) PCT No.: PCT/JP2007/052076

§ 371 Date: Aug. 8, 2008

(30) Foreign Application Priority Data
Feb. 8, 2006 (JP) 2006-030400

(51) Int. Cl. H01Q 9/04; H01Q 1/24

(52) U.S. Cl. 343/702; 343/700 MS; 343/791

(57) ABSTRACT

An antenna device which is very compact, low in profile, wide in bandwidth, simple in configuration and inexpensive is provided. A plate type wideband antenna device according to the present invention is formed with a radiation element which is formed by bending a tapered conductor plate 11 into a rough squared U shape, a conductor 12 which serves as a ground plate and a coaxial cable 1 which feeds power, and is configured by connecting the coaxial center conductor 2 of the coaxial cable to the tapered conductor 11 of a squared U shape and connecting the coaxial external conductor 3 to the ground plate 12. By this, a very small antenna device whose entire size is 0.2 wavelengths long, 0.1 wavelengths wide and 0.1 wavelengths high relative to the frequency used is obtained.

### TECHNICAL FIELD

The present invention relates to an antenna device and an electronic device using the same. More particularly, the present invention relates to an antenna device which is used as an antenna to realize a universal serial bus (USB) wirelessly via the ultra-wide band (UWB) technology and a communication device using the same.

### BACKGROUND ART

Demand has been increasing for antennas such as wireless LAN for use on wireless TVs (televisions) using the UWB technology as well as for use on smaller information communication devices, such as notebook PCs (notebook personal computers), PDAs (Personal Digital Assistants; personal portable information devices) and other mobile terminals. A typical frequency range for communication using the UWB technology is between 3.1 GHz to 4.9 GHz. Therefore, antennas must operate over very wide bandwidths in such applications.

Furthermore, for electronic devices with USB interfaces, compactness has recently become one of the most important features. A representative example of such a device is USB memory sticks. The outer dimensions of a typical USB memory stick are 60 mm long, 15 mm wide and 12 mm thick. Therefore, stick-shaped USB devices implementing the UWB technology are required to be correspondingly small. In such a small USB device, a printed board implemented in the device is at largest 50 mm long×10 mm wide, with the area available to the antenna part being around 20 mm in length×10 mm in width. In this context, an antenna will have a great advantage if it can be configured to be as compact as 20 mm long×10 mm wide and to have a low profile of 11 mm high.

Conversion of this size based on the lowest useful frequency of 3.1 GHz results in approximately 0.2 wavelengths in height×0.1 wavelengths in width×approximately 0.12 wavelengths in height. This represents a very compact wideband antenna. However, on such an antenna, it is extremely difficult to achieve a height of 11 mm.

One example of wideband antennas according to related arts is a disc cone antenna as shown in FIG. 16. In this figure, 101 is a disc, 102 is a cone, 103 is a coaxial cable, 104 is a coaxial center conductor, and 105 is an coaxial outer conductor. In Literature 1, a small antenna for UWB applications is disclosed. This antenna has a conductor pattern provided, sandwiched between upper and lower dielectrics. The conductor pattern has a feeding point at the front center, and is formed by an inverted triangle part having tapered sections which respectively extend from the feeding point toward the right and left side faces and a rectangular part which contacts with the upper hem of the inverted triangle part.

Literature 1: Japanese Patent Laying-Open Publication No. 2005-094437

Disc cone antennas like the one shown in FIG. 16 can provide wideband properties but have several drawbacks. These antennas are large in size, sterically formed and complex in design. They are also expensive. The most critical drawback of these antennas is that they cannot be accommodated within USB stick shapes which have become very popular on the market in recent years.

The antenna for UWB applications described in Literature 1 has compact and wideband properties but is problematic in several points. Firstly, it requires both upper/lower dielectrics and a conductor pattern. Secondly, the planar shape of the conductor pattern limits the maximum length of the antenna, and consequently the maximum frequency thereof, when it is accommodated in a USB stick shape. And thirdly, the height of the antenna exceeds 22 mm, which also prevents the antenna from being accommodated in a USB stick shape.

An object of the present invention is to provide an antenna device which is very compact, low in profile, wide in bandwidth, simple in configuration and inexpensive and a communication device using the same.

Another object of the present invention is to provide an antenna device for UWB applications which can be accommodated in a USB stick shape and a communication device using the same.

### SUMMARY

According to an exemplary aspect of the invention, an antenna device, may include a radiation element formed by bending a conductor plate with diminishing width by approximately 180 degrees; a feeding point at the tip of the taper shape of the radiation element; and a rectangular ground plate which is roughly in parallel with a conductor plate in which the feeding point is included.

According to an exemplary aspect of the invention, an antenna device, include a ground part provided over the entire back surface of the printed board; a micro strip made up of a constant-width part which is provided on the surface of the printed board and a tapered part which is connected to the tip of the constant-width part and which has increasing width when viewed from the connection section thereof; and a radiation element which is obtained by bending a conductor plate with diminishing width into a rough squared U shape or a rough U shape; and wherein the tip of the diminishing taper of the radiation element is connected to the largest-width portion of the tapered part.

According to an exemplary aspect of the invention, a communication device is a wireless device connectable to a USB (Universal Serial Bus) stick which built in the antenna device.

According to the present invention, there is an effect that an antenna device which is very compact, low in profile, wide in bandwidth, simple in configuration and inexpensive can be obtained. According to the present invention, there is also an effect that an antenna device for UWB applications which can be accommodated in a USB stick shape can be obtained.

### BRIEF DESCRIPTION OF THE DRAWINGS

FIG. 1 is a perspective view which shows the configuration of a first exemplary embodiment according to the present invention;

FIG. 2 is a side view for the first exemplary embodiment according to the present invention;

FIG. 3 is a side view which shows the configuration of a second exemplary embodiment according to the present invention;

FIG. 4 is a side view which shows the configuration of a third exemplary embodiment according to the present invention;

FIG. 5 is a side view which shows the configuration of a fourth exemplary embodiment according to the present invention;

FIG. 6 is a side view which shows the configuration of a fifth exemplary embodiment according to the present invention;

FIG. 7 is a perspective view which shows the configuration of a sixth exemplary embodiment according to the present invention;

FIG. 8 (A) is a perspective view which shows the configuration of a seventh exemplary embodiment according to the present invention, and (B) is its side view;

FIG. 9 is a diagram which shows exemplary variations of the shape of the conductor;

FIG. 10 is a diagram which shows other exemplary variations of the shape of the conductor;

FIG. 11 is a diagram which shows yet other exemplary variations of the shape of the conductor;

FIG. 12 is a diagram which shows different types of exemplary variations of the shape of the conductor;

FIG. 13 is a diagram which shows yet other types of exemplary variations of the shape of the conductor;

FIG. 14 is a perspective view which shows a prototype configuration of a plate type wideband antenna according to the present invention;

FIG. 15 is a diagram which shows the return loss properties of the plate type wideband antenna according to the present invention; and

FIG. 16 is a diagram which shows an example of an antenna according to a related art.

### EXEMPLARY EMBODIMENT

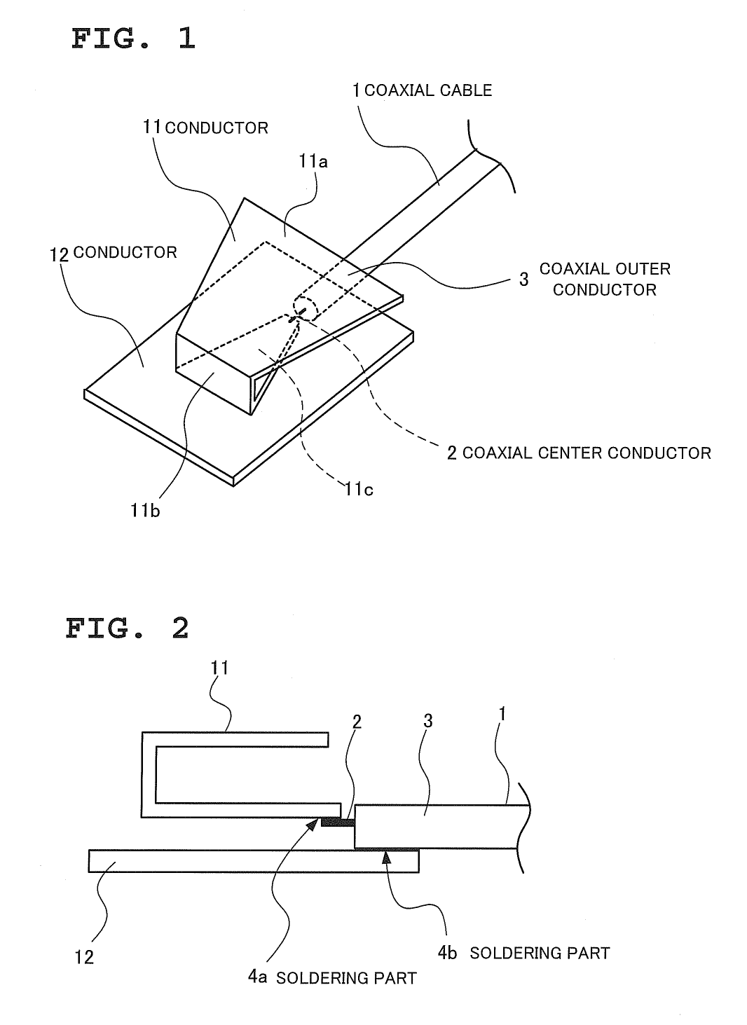

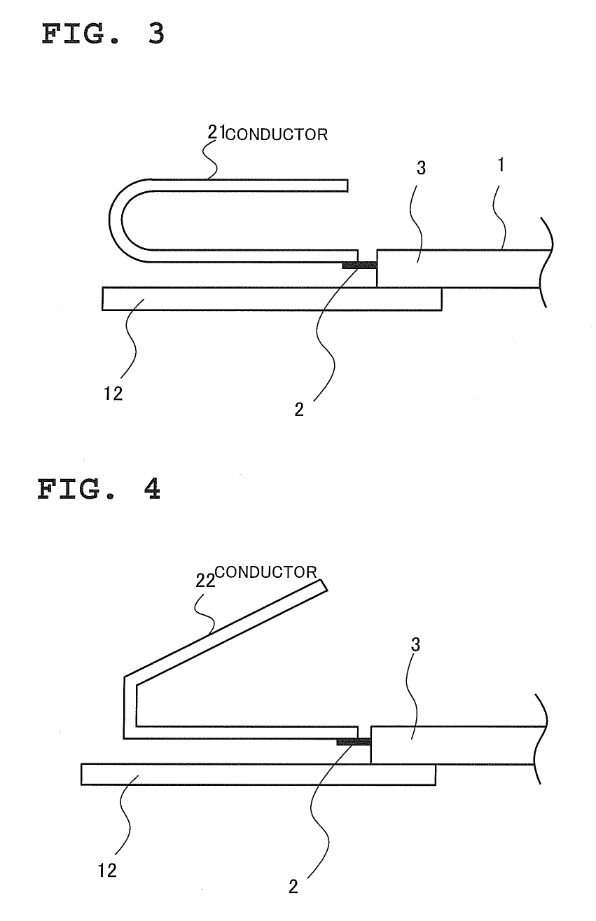

Exemplary embodiments according to the present invention will be described below with reference to the drawings. FIG. 1 is a perspective view for a plate type wideband antenna used for a communication device according to a first exemplary embodiment of the present invention, and FIG. 2 is its side view. The plate type wideband antenna according to this exemplary embodiment comprises a conductor 11 which serves as a radiation element and which is formed by folding a conductor plate tapered with diminishing width toward the tip roughly into a squared U shape (that is, by bending the plate by an angle of approximately 180 degrees); a conductor 12 which consists of a rectangular conductor to serve as a ground plate; and a coaxial cable 1 for power feed purposes.

As shown in FIG. 1, the conductor 11, which serves as a radiation element, comprises a conductor part 11a of a trapezoidal shape; a conductor part 11b of a rectangular shape; and a conductor part 11c of a triangular shape. The trapezoidal conductor part 11a and the triangular conductor part 11c are connected roughly parallel to each other via the rectangular conductor part 11b which is vertically placed.

Power feed to this antenna is achieved by connecting the coaxial center conductor 2 of the coaxial cable 1 to the end (or, the apex) of the triangular conductor part 11c of the conductor 11 and also connecting the tip of the coaxial outer conductor 3 to the end of the conductor 12.

In other words, the tip, i.e., the most tapered part of the conductor 11, which serves as a radiation element, becomes the feeding point. The rectangular conductor 12 which serves as a ground plate is provided in parallel to the triangular conductor part 11c, which includes the feeding point.

There are two effects provided by making the conductor 11 tapered with increasing width when viewed from the feeding point to which the coaxial center conductor 2 is connected. The first effect is the ability to support wider bandwidths and the second is improved impedance matching.

First, the reasons for the ability to support wider bandwidths will be explained. In general, electric current distributed over the radiation element of this type of antenna depends on wavelengths. If the conductor 11 were of a linear shape, it would be impossible for the antenna to operate across wide bandwidths because only wavelengths corresponding to the length of the conductor could be distributed. A tapered conductor, to the contrary, can handle a wide variety of wavelengths. This is because the length from the feeding point to which the coaxial center conductor 2 is connected to the tip of the folded conductor 11 varies widely.

For example, the length along either end of the conductor is long, which means long wavelengths, i.e., low frequencies, can be handled. The length in the central part is the shortest, which means that a high frequency corresponding to this length can be handled. The portions between the lines along the ends and the line along the center are of lengths inbetween. This is the reason why wider bandwidths can be supported.

Next, the reasons for improved impedance matching will be explained. The improvement in impedance matching partly relates to the use of a squared U shape for the conductor 11. The conductor 11 is folded into a squared U shape to make the antenna to have a low profile (or to be low in height). The main goal of this antenna invention is to realize an antenna which can support a bandwidth range between 3.1 GHz and 4.9 GHz and which is small enough to be implemented in a compact housing, notably a USB memory stick. To achieve this goal, it is critical for the antenna to have a low profile. In particular, a height of around 11 mm is the greatest permissible level from viewpoints of portability and aesthetic design. A squared U shape has been chosen to achieve this level of height.

However, simply using a squared U shape is not enough to obtain good impedance matching. By gradually increasing the width of the conductor 11 or, in other words, by making the conductor 11 tapered with increasing width, when viewed from the feeding point to which the coaxial center conductor 2 is connected, it can be ensured that impedance conversion takes place gradually and consequently good impedance matching can be achieved.

In this respect, the conductor 12 serves as a ground plane. This antenna is basically an application of monopole antenna. If the conductor 11 is considered as a wideband and low-profile radiation element, then the conductor 12 can be considered as a ground plane. The conductor 12 in itself is desirably of an infinite size or, at least, of a sufficient size relative to the wavelengths used.

However, the main goal of this antenna invention is to realize an antenna which can support a bandwidth range between 3.1 GHz and 4.9 GHz and which is small enough to be implemented in a compact housing, notably a USB memory stick. To achieve this goal, the area available to the ground is limited to around 10 mm×20 mm. Since the conductor 12 serves as a ground plane, it must be made to have the maximum permissible area if not sufficiently large to support the wavelengths used, in order to achieve the best possible properties within the constraint. For this reason, 10 mm×20 mm has been chosen as the size of the conductor 12.

Choosing an optimum size is not enough to obtain sufficient impedance matching, and thus several other adjustments have been made, including placing the conductor 12 at an appropriate distance from the conductor 11, modifying the tapered shape of the conductor 11 and changing the capacitances of the conductor 11 and the conductor 12.

Referring to the side view of FIG. 2, it is indicated that the coaxial center conductor 2 of the coaxial cable 1 is connected to the end of the conductor 11 by means of soldering 4a, and the tip of the coaxial outer conductor 3 is connected to the end of the conductor 12 by means of soldering 4b.

FIG. 3 is a side view which shows the configuration of a second exemplary embodiment according to the present invention. The second exemplary embodiment differs from the first exemplary embodiment shown in FIGS. 1 and 2 in that the left end of the conductor 21 is folded roughly into a round U shape, rather than a squared U shape. This exemplary embodiment has similar effects to those of the first exemplary embodiment.

FIG. 4 is a side view which shows the configuration of a third exemplary embodiment according to the present invention. The third exemplary embodiment differs from the first exemplary embodiment shown in FIGS. 1 and 2 in that the conductor 22 extends diagonally to the upper right direction, rather than being of a squared U shape. In other words, the conductor 22 gradually increases in angle in the direction toward the opening at the end of the squared U shape. This shape is a little disadvantageous in terms of low profile.

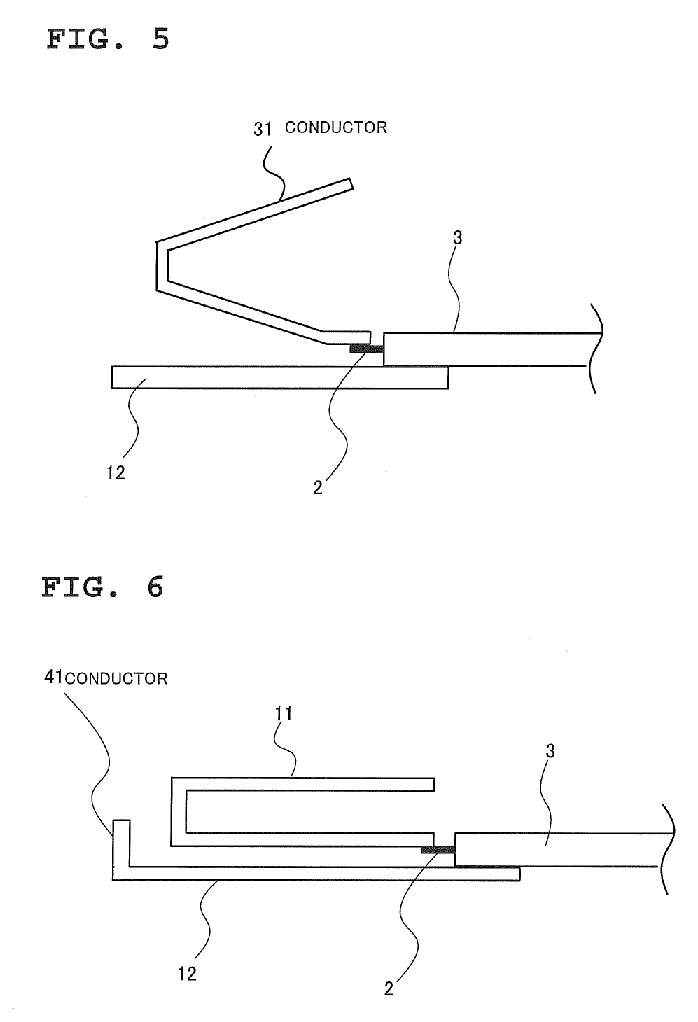

FIG. 5 is a side view which shows the configuration of a fourth exemplary embodiment according to the present invention. The fourth exemplary embodiment differs from the third exemplary embodiment shown in FIG. 4 in that the lower part of the conductor 31 extends diagonally to the upper left direction. In this exemplary embodiment as well, the conductor 31 gradually increases in angle in the direction toward the opening at the end of the squared U shape. This shape is also disadvantageous in terms of low profile.

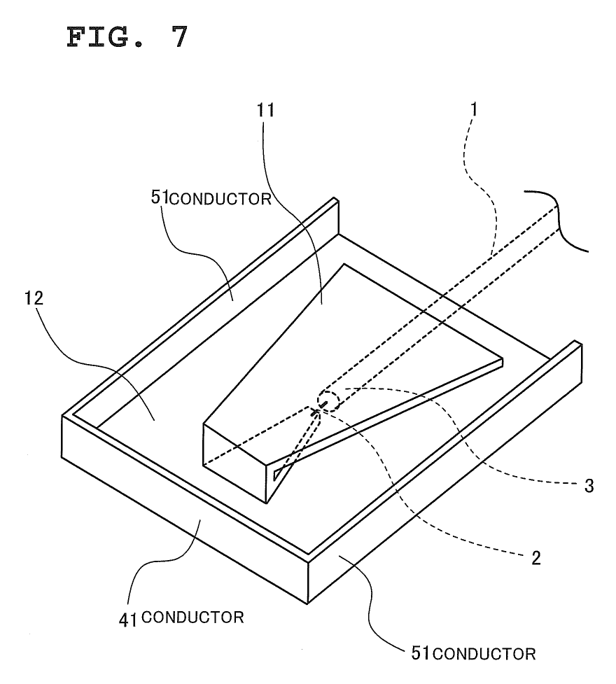

FIG. 6 is a side view which shows the configuration of a fifth exemplary embodiment according to the present invention. The fifth exemplary embodiment differs from the first exemplary embodiment shown in FIGS. 1 and 2 in that a conductor 41 is added to the tip (or the tip edge) of the conductor 12 vertically, forming a wall-like surface. FIG. 7 is a perspective view which shows the configuration of a sixth exemplary embodiment according to the present invention. The sixth exemplary embodiment differs from the fifth exemplary embodiment shown in FIG. 6 in that conductors 51 are added on both the sides (or the edges) of the conductor 12 vertically, forming wall-like surfaces.

The addition of the conductor 41 and the conductors 51 as shown in FIGS. 6 and 7 produces the following two effects. The first effect is improved impedance matching and the second the ability to restrict the directions of radiation. As explained in the description of FIG. 1, impedance matching for this antenna is improved by using a tapered shape for the conductor 11 and adjusting capacitance resulting from its distance with the conductor 12. In this case, the provision of additional conductors, such as conductors 41 and 51, makes impedance matching easier, because fine adjustments in capacitance with the conductor 11, which are otherwise difficult, can be easily made.

Moreover, since the conductor 12 can function as a ground plane, radio waves are primarily radiated upward over the conductor 11. At this time, radiated waves reach the back side of the conductor 12 because the conductor 12 is small in size. However, the provision of the conductor 41 or the conductors 51 gives rise to effects like those of small reflectors. By this, wave radiation becomes stronger than without the conductor 41 or the conductor 51 and the amount of radio waves which reaches the back side (the down side) of the conductor 12 reduces. Thus, more radiated waves can be attracted upward.

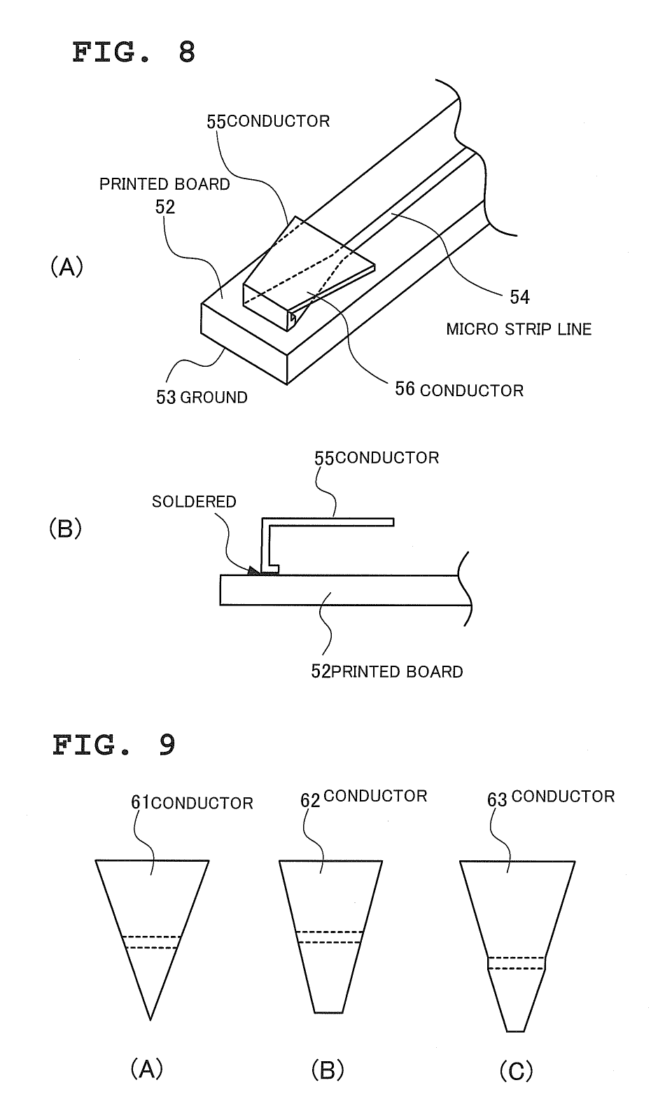

FIG. 8 is a perspective view which shows the configuration of a seventh exemplary embodiment according to the present invention. This exemplary embodiment differs from the first to sixth exemplary embodiments in that it is configured by using a printed board 52. A ground 53 consisting of a conductor is provided at the bottom face of the printed board 52, and a micro strip line 54 consisting of a conductor is provided on the upper right face. The micro strip line 54 forms, together with the ground 53, a so-called micro strip line and functions as an alternative to the coaxial cable 1 shown in FIG. 1. A tapered conductor 56 is formed at the left tip of the micro strip line 54. A tapered conductor 55 of a squared U shape is soldered to the left end of the tapered conductor 56.

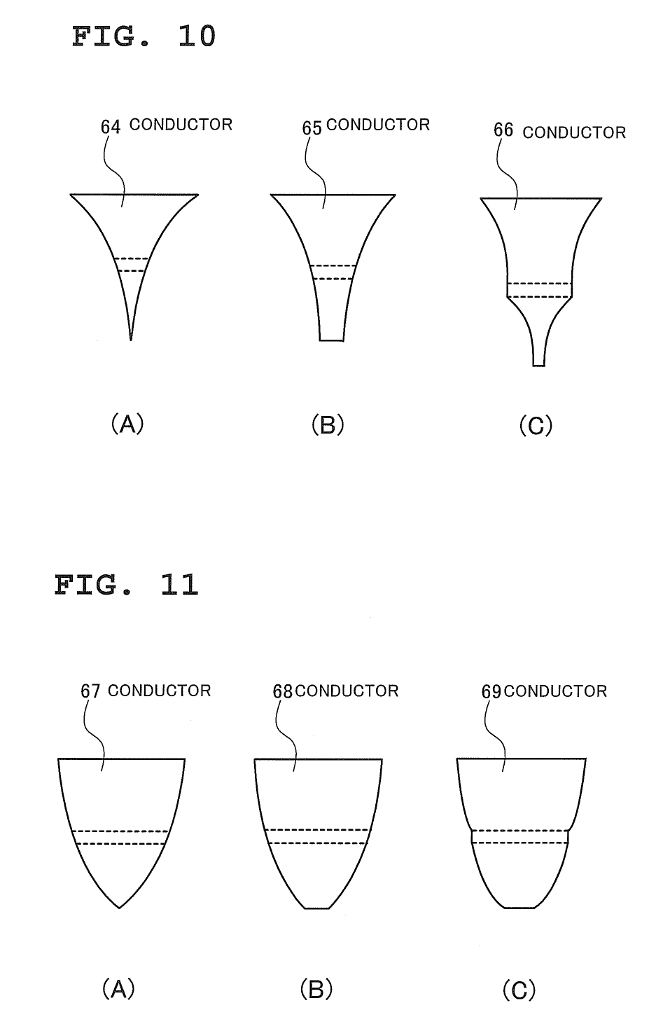

FIGS. 9 to 13 show examples of various alternative shapes for the conductor 11 according to the first to sixth exemplary embodiments. FIG. 9 (A) is of a triangular shape and is folded along the two dotted lines in the center to form a squared U shape. FIG. 9 (B) is of a trapezoidal shape formed by cutting the lower tip of (A) and is folded along the two dotted lines in the center to form a squared U shape. FIG. 9 (C) is the same as (B) except that the right and left sides of the portion between the two dotted lines in the center are straight lines.

FIG. 10 (A) is the same as (A) of FIG. 9 except that the two sides of the triangular shape are curves, each with a taper with sharply diminishing width toward its tip. FIG. 10 (B) is a shape formed by cutting the lower tip of (A). FIG. 10 (C) is the same as (B) except that the right and left sides of the portion between the two dotted lines in the center are straight lines.

FIG. 11 (A) is an inversed version of FIG. 9 (A), in which the two sides of the triangular shape are curves, each with a taper with increasing width. FIG. 11 (B) is a shape formed by cutting the lower tip of (A). FIG. 11 (C) is the same as (B) except that the right and left sides of the portion between the two dotted lines in the center are straight lines.

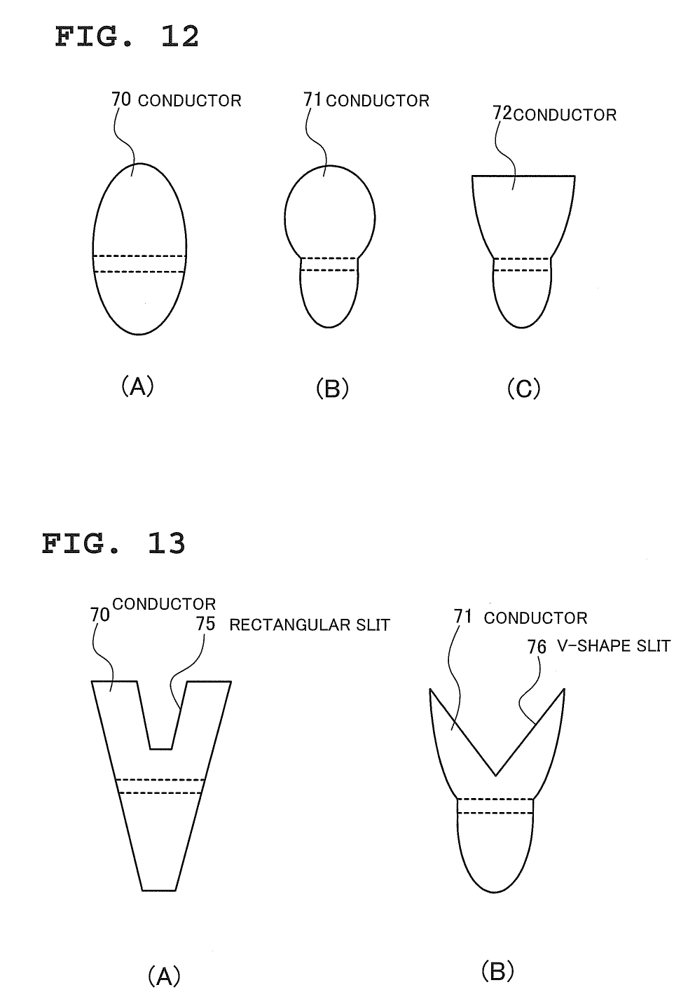

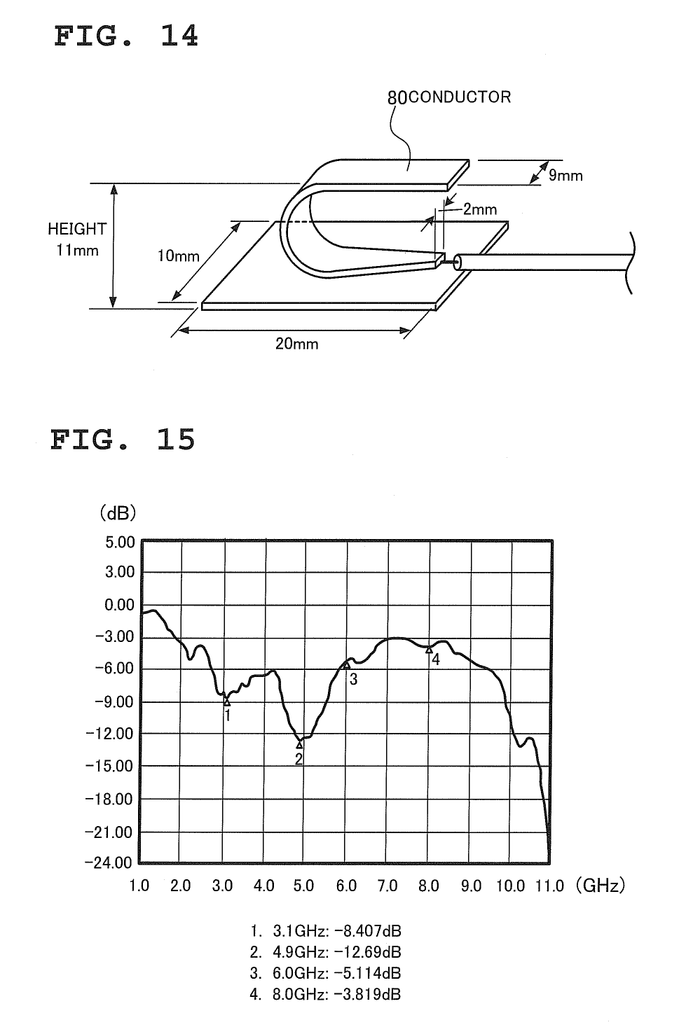

FIG. 12 (A) is an elliptically shaped conductor. FIG. 12 (B) is a shape formed by connecting a large ellipse and a small ellipse with each other and providing a straight-lined portion at the connection. FIG. 12 (C) is a shape formed by cutting the upper tip of (B). FIG. 13 (A) is a shape formed by cutting a rough rectangle out of, or providing a slit in, the upper part of FIG. 9 (B). FIG. 13 (B) is a shape formed by cutting the upper part of FIG. 12 (C) into a V shape (or cutting a triangle slit out of FIG. 12 (C)).

The shapes of FIGS. 9 through 13 may be implemented in various combinations. These shapes may also be applied alternatively to the shape formed by combining the conductor 55 and the conductor 57 according to the seventh exemplary embodiment shown in FIG. 8. Furthermore, the folding part along the dotted lines explained in the description above may be bent roundly as shown in FIG. 3.

In the foregoing, the shape of FIG. 12 and other similar shapes are more of an elliptical shape than a tapered shape. However, from the perspective of the principle of supporting wider bandwidths and that of impedance matching for this antenna, it will be readily expected that such a shape can achieve the same effects which are obtained when a tapered device is used.

For example, with respect to the principle of supporting wider bandwidths, the use of the shape of (A) or (B) in FIG. 12 produces various lengths from the feeding point to which the coaxial center conductor 2 is connected up to the tip of the folded-over conductor 70 or 71 as explained in the description of wide bandwidths with reference to FIG. 1.

With respect to the principle of impedance matching as well, the increasing width of the conductor 70 or 71 when viewed from the feeding point to which the coaxial center conductor 2 is connected leads to the effects that impedance conversion takes place gradually.

FIGS. 13 (A) and (B) are of a shape with a slit in the upper part. The same idea is applicable to these shapes because, from the perspective of the principle of supporting wider bandwidths, these shapes produce various lengths from the feeding point to which the coaxial center conductor 2 is connected up to the tip of the folded-over conductor 73 or 74, as explained in the description of wide bandwidths with reference to FIG. 1 even by using the shape of the conductors 73 and 74.

FIG. 14 shows the shape and dimensions of a plate type wideband antenna actually prototyped according to the present invention. The shape of the conductor 80, which corresponds to the shape of the conductor 11 of FIG. 1, corresponds to the FIG. 11 (B) shape, which is folded into a round U shape.

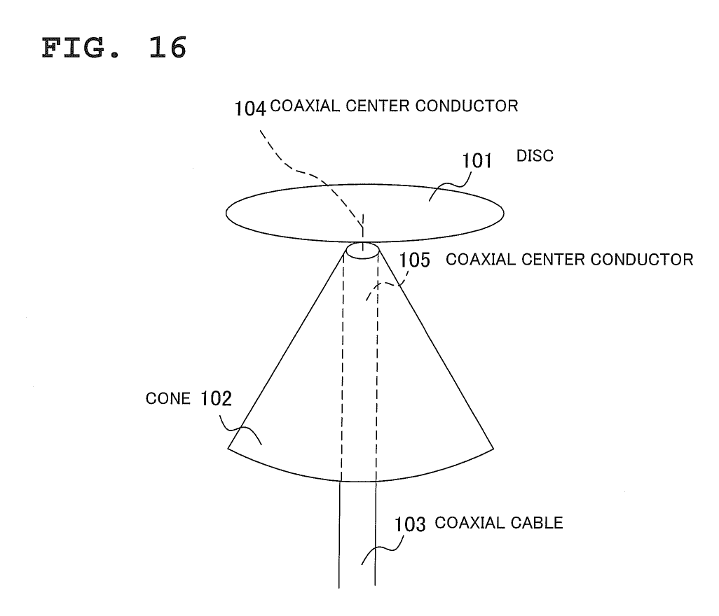

FIG. 15 shows the return loss properties of the plate type wideband antenna of FIG. 14. As shown in this figure, within a range between 3.1 GHz and 4.9 GHz, a return loss of 6 dB has been obtained, along with a VSWR of 3.0 or less.

As described above, the plate type wideband antenna according to the present invention is a compact antenna with a size of 10 mm wide, 20 mm long and 11 mm high and a bandwidth coverage of 3.1 GHz to 4.9 GHz. Conversion of this size based on the lowest useful frequency of 3.1 GHz results in the length, width and height of the overall antenna device of approximately 0.2 wavelengths, approximately 0.1 wavelengths and 0.1 wavelengths, respectively. In summary, the present invention is characterized by its ability to allow easy configuration of a very compact, low in profile, wide in bandwidth and inexpensive antenna.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An antenna device, including:
a radiation element formed by bending a conductor plate with diminishing width; a feeding point at the tip of the taper shape of said radiation element; and a ground plate which is roughly in parallel with a conductor plate in which said feeding point is included.

2. The antenna device according to claim 1, wherein said radiation element is formed by bending said conductor plate into a rough U shape.

3. The antenna device according to claim 1, wherein said rough U shape is gradually increased in angle in the direction toward the opening at the end thereof.

4. The antenna device according to claim 1, wherein an internal conductor of a coaxial cable is connected to said feeding point and an external conductor of said coaxial cable is connected to said ground plate.

5. The antenna device according to claim 1, further including a conductor provided vertically at the edge of said ground plate.

6. The antenna device according to claim 1, further including
feeding means for feeding current into said radiation element through said feeding point.

7. The antenna device according to claim 1, wherein the diminishing taper of said radiation element is a linear taper.

8. The antenna device according to claim 1, wherein the diminishing taper of said radiation element is a curved taper.

9. The antenna device of claim 1, wherein a slit is provided at the largest width portion of said radiation element.

10. The antenna device according to claim 1, wherein an elliptically shaped radiation element is provided in place of said radiation element with a diminishing taper.

11. The antenna device according to claim 1, the length, width and height of the entire antenna device are approximately 0.2 wavelengths, approximately 0.1 wavelengths and approximately 0.1 wavelengths, respectively, relative to the wavelength of the lowest of the frequencies used.

12. A communication device, comprising the antenna device of claim 1.

13. The communication device according to claim 12, wherein the communication device is a wireless device connectable to a USB (Universal Serial Bus) stick which built in the antenna device.

14. The antenna device according to claim 1, wherein
said radiation element is formed by bending said conductor plate by approximately 180 degrees.

15. The antenna device according to claim 6, wherein said feeding means is a coaxial cable or a micro strip line.

16. The antenna device according to claim 6, including:
a printed board; a ground part provided over the back surface of said printed board; and said micro strip line provided on the surface of said printed board;
wherein the tip of the diminishing taper of said radiation element is connected to said micro strip line.

17. The antenna device according to claim 6, wherein
said micro strip line made up of a constant-width part which is provided on the surface of said printed board and a tapered part which is connected to the tip of the constant-width part and which has increasing width when viewed from the connection section thereof, the tip of the diminishing taper of said radiation element is connected to tapered part of said micro strip line.
